(19) United States
(12) Patent Application Publication
(10) Pub. No.: US 2009/0086262 A1
(43) Pub. Date: Apr. 2, 2009

(54) JOB EXECUTING APPARATUS FOR EXECUTING A JOB IN RESPONSE TO A RECEIVED COMMAND AND METHOD OF EXECUTING A JOB IN RESPONSE TO A RECEIVED COMMAND

(75) Inventor: Takanobu SUZUKI, Nagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/234,015

(22) Filed: Sep. 19, 2008

(30) Foreign Application Priority Data
Oct. 1, 2007 (JP) 2007-258090

(51) Int. Cl. G06F 3/12

(52) U.S. Cl. 358/1.15

(57) ABSTRACT

A job executing apparatus is provided with a job ID creation device configured to create a job ID in a case where a first command and an external apparatus ID of an external apparatus are received, a sending device configured to send the job ID to the external apparatus, a storing device configured to store combination data of the job ID and the external apparatus ID, a second command determination device configured to determine whether or not combination data received with a second command is stored in the storing device, and a job executing device configured to execute a job corresponding to the job ID received with the second command in a case where a positive determination is made, and configured to prohibit executing the job corresponding to the job ID received with the second command in a case where a negative determination is made.

### CROSS-REFERENCE TO RELATED APPLICATION

This application claims priority to Japanese Patent Application No. 2007-258090 filed on Oct. 1, 2007, the contents of which are hereby incorporated by reference into the present application.

### FIELD OF THE INVENTION

The technique described in this specification relates to a technique for executing a job in response to a command from other apparatus. More particularly, it relates to a job executing apparatus and a job executing method. In this specification, it should be noted that a “job” means a function to be carried out by an apparatus. For example, a printer is a job executing apparatus for executing a job, namely, a printing function in response to a command from other apparatus. Further, a scanner is a job executing apparatus for executing a job, namely, a scanning function in response to a command from other apparatus.

### DESCRIPTION OF THE RELATED ART

A printer for executing a printing job in response to a command from an external apparatus is widely known. There are various standards for command communication between the external apparatus and the printer. For example, there is a standard referred to as Web Services. In this communication standard, communication is established between the external apparatus and the printer based on a standard referred to as a Web Services Printer Service. In the Web Services Printer Service, commands are transmitted from the external apparatus to the printer in two steps. More specifically, first the external apparatus transmits to the printer a command named “Create Print Job Request” (hereinafter referred to as a CPJR command). When receiving the CPJR command, the printer creates a job ID. At a time when the job ID is created, a printing job is in print waiting state. The printer transmits the created job ID to the external apparatus. Thus, the external apparatus can obtain the job ID. Next, the external apparatus transmits to the printer a command named “Send Document Request” (hereinafter referred to as a SDR command) together with the job ID (obtained by the external apparatus). When receiving the SDR command and the job ID, the printer executes a printing job corresponding to the received job ID.

Japanese Patent Application Publication No. 2000-330738 discloses the following technique. In this technique, when a printer is caused to execute printing, a computer transmits to the printer (printer server) an occupation request and a machine name of the computer. When receiving the occupation request and the machine name, the printer server stores the machine name and a time period during which the computer is allowed to occupy the printer. Next, the computer transmits a print request and the machine name of the computer to the printer server. When receiving the print request and the machine name, the printer server determines whether or not the machine name received with the print request coincides with the machine name stored. In a case where the machine names coincide with each other, the printer executes printing. On the other hand, in a case where the machine names do not coincide with each other, the print request will be denied.

### BRIEF SUMMARY OF THE INVENTION

According to the former technique described above (technique utilizing the Web Services Printer Service), a printer transmits a job ID to an external apparatus (hereinafter may be referred to as a first external apparatus in this specification) in response to a CPJR command, and then the first external apparatus transmits to the printer a SDR command together with the job ID. There may be a case where the job ID transmitted to the first external apparatus from the printer is obtained by another external apparatus (hereinafter may be referred to as a second external apparatus in this specification). The second external apparatus is capable of obtaining (e.g., fraudulent obtainment) a job ID transmitted to the first external apparatus from the printer, by monitoring the communication between the first external apparatus and the printer. Further, before the first external apparatus transmits to the printer the SDR command together with the job ID, the second external apparatus is capable of transmitting a SDR command together with the same job ID. In this case, the printer executes a printing job in response to the SDR command from the second external apparatus. In other words, the printing job interruption may occur. The technique for transmitting commands from an external apparatus to a printer in two steps involves a possibility of printing job interruption.

According to the latter technique described above (technique in Japanese Patent Application Publication No. 2000-330738), the external apparatus (computer in the example described above) occupies a printer for a predetermined time. While the printer is occupied, a request for printing transmitted from another external apparatus is denied by the printer. Therefore, the printing job interruption is prohibited. However, in this technique, another problem may arise resulting from the fact that the external apparatus occupies the printer. More specifically, the printer being occupied is not capable of accepting a request for printing from another external apparatus (second external apparatus). Thus, the second external apparatus whose request had been denied has to transmit the request for printing again after the occupation of the printer is terminated. For example, it is required for a user of the second external apparatus to carry out the operation for transmitting the request for printing again.

This specification provides a novel job executing apparatus which is capable of prohibiting job interruption (that is, a job execution by a second external apparatus using a job ID transmitted to a first external apparatus) without being occupied by an external apparatus.

The present inventor focused attention on the fact that an external apparatus ID of an external apparatus is transmitted to a job executing apparatus together with a command. More specifically, the job executing apparatus disclosed in this specification prevents job interruption taking advantage of the external apparatus ID to be transmitted together with the command.

The job executing apparatus disclosed in this specification executes a job in response to a received command. The job executing apparatus comprises a receiving device, a job ID creation device, a sending device, a storing device, a second command determination device, and a job executing device. The receiving device is configured to receive a command. The job ID creation device is configured to create a job ID in a case where the receiving device receives a first command and an external apparatus ID of an external apparatus. The sending device is configured to send the job ID to the external apparatus. The storing device is configured to store combination data of the job ID and the external apparatus ID. The second command determination device is configured to determine, in a case where the receiving device receives a second command, a job ID, and an external apparatus ID of an external apparatus, whether or not combination data of the job ID and the external apparatus ID received with the second command is stored in the storing device. The job executing device is configured to execute a job corresponding to the job ID received with the second command in a case where the second command determination device makes a positive determination, and is configured to prohibit executing the job corresponding to the job ID received with the second command in a case where the second command determination device makes a negative determination.

The receiving device may receive various commands including the first command and the second command. Further, the receiving device may receive, along with a command, data including ID information of the sender of the command (i.e., an external apparatus) and job to be executed. The job executing apparatus stores, in storing device, combination data of the job ID and the external apparatus ID of the external apparatus which transmitted the first command. The job executing apparatus executes a job under the condition that the second command is received with the same combination data as the combination data stored in the storing device. Therefore, even in a case where the second command is transmitted from another external apparatus to the job executing apparatus together with the aforementioned job ID and an external apparatus ID of the another external apparatus, the job executing apparatus prohibits executing the job because the combination data received with the second command (the job ID and an external apparatus ID of the another external apparatus) does not coincide with the combination data stored in the storing device. Further, the job executing apparatus is capable of distinguishing jobs by means of job IDs, and capable of accepting job execution requests (that is, first command) from a plurality of external apparatuses in parallel manner. More specifically, in a case where the job executing apparatus receives, while executing a job requested from an external apparatus, a job execution request from another external apparatus, the job executing apparatus is capable of carrying out the job for the former external apparatus and simultaneously creating a job ID and then transmitting the job ID to the latter external apparatus in response. Thus, job interruption is prevented without a problem that the job executing apparatus is occupied and cannot accept a job execution request from another external apparatus.

### BRIEF DESCRIPTION OF THE DRAWINGS

FIG. 1 is a connection diagram of a printer 10 and external apparatuses.

FIG. 2 is a block diagram illustrating internal composition of the printer 10.

FIG. 3 illustrates descriptive contents of a combination database 30.

FIG. 4 illustrates descriptive contents of an improper ID database 32.

FIG. 5 is a flowchart illustrating a process of the printer 10 carrying out printing.

FIG. 6 illustrates a content of a packet for transmitting a CPJR command.

FIG. 7 is a flowchart illustrating a process of combination data storing step.

FIG. 8 illustrates a content of a packet for transmitting a SDR command.

FIG. 9 is a flowchart illustrating a process of packet determination step.

FIG. 10 is a flowchart illustrating a process of canceling printing.

FIG. 11 is a flowchart illustrating a deleting process of an improper ID from the improper ID database 32.

FIG. 12 is a flowchart illustrating a process of a scanner 60 carrying out scanning.

### DETAILED DESCRIPTION OF THE INVENTION

### First Embodiment

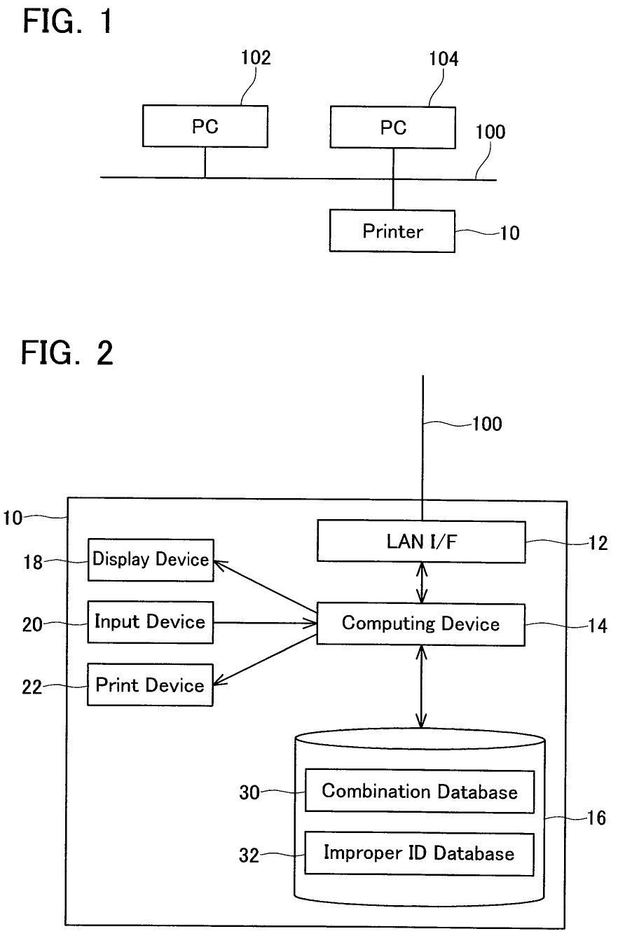

The job executing apparatus according to a first embodiment will be described with reference to the accompanying drawings. In the first embodiment, a printer which functions as a job executing apparatus will be described. FIG. 1 is a block diagram illustrating composition of a network including a printer 10 of this embodiment. As shown in FIG. 1, the printer 10 is connected with a plurality of external apparatuses, such as a PC 102 and a PC 104, via a LAN 100. The printer 10 and these external apparatuses communicate with each other in accordance with a Web Services standard (that is, Web Services Printer Service). The printer 10 carries out printing in response to a request from one of the external apparatuses.

### (Composition of Printer 10)

FIG. 2 is a block diagram illustrating composition of the printer 10. As shown in FIG. 2, the printer 10 includes a LAN interface 12, a computing device 14, a storing device 16, a display device 18, an input device 20, and a print device 22.

The LAN interface 12 is connected to the external apparatuses via the LAN 100. The LAN interface 12 receives data from the computing device 14 and then transmits the input data to an external apparatus. Further, the LAN interface 12 receives data transmitted from an external apparatus and then outputs the received data to the computing device 14.

The computing device 14 is connected with the LAN interface 12, the storing device 16, the display device 18, the input device 20, and the print device 22. The computing device 14 carries out various computing, controlling respective components of the printer 10, inputting data to the respective components, and outputting data from the respective components.

The storing device 16 is capable of storing various data. Data stored in the storing device 16 is read by the computing device 14. Further, the storing device 16 receives data from the computing device 14 and then stores the data. A combination database 30 and an improper ID database 32 are stored in the storing device 16.

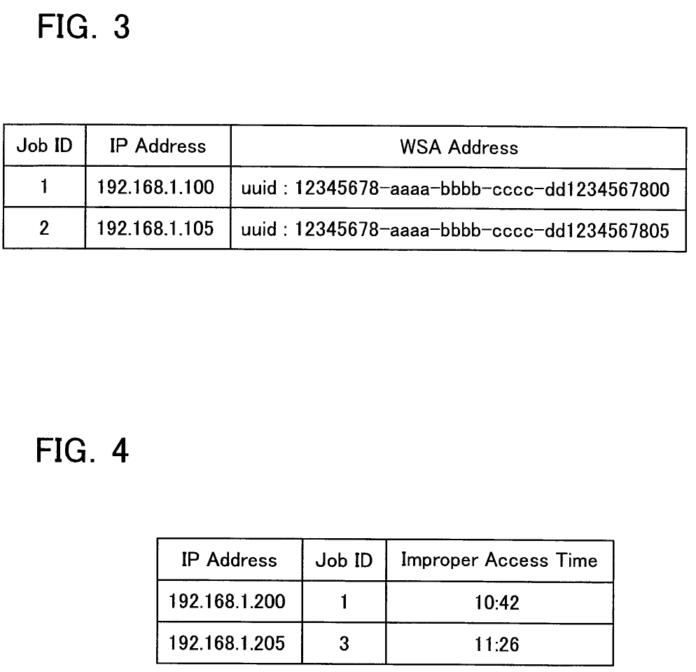

The combination database 30 is a database into which data of a job which is under print execution or in print waiting state is described. As shown in FIG. 3, the combination database 30 is a list of data stored in such a manner that a job ID, an IP address of an external apparatus, and a WSA address of the external apparatus are associated with each other. Hereinafter, each data included in the combination database 30 (that is, the data constructed of a job ID, an IP address, and a WSA address) is referred to as combination data. Each combination data is stored (described) when the printer 10 receives a CPJR command which will be described later.

The improper ID database 32 is a database into which data of an external apparatus which has executed improper access to the printer 10 is described. The improper access means a command transmission to the printer 10 together with combination data which is not described in the combination database 30. As shown in FIG. 4, the improper ID database 32 is a list of data stored in such a manner that an IP address of an external apparatus, a job ID, and improper access time are associated with each other. Hereinafter, each IP address included in the improper ID database 32 is referred to as an improper ID. The improper ID is stored (described) each time when an external apparatus executes improper access to the printer 10.

The display device 18 is a liquid crystal display, which displays information in response to a command from the computing device 14.

The input device 20 is composed of a plurality of input buttons and the like. By user's operation of the input buttons, the input device 20 inputs a command into the computing device 14.

The print device 22 is mainly composed of a paper tray, a paper carrying mechanism, an ink jet head, an ink jet head driving mechanism, and the like. The print device 22 feeds paper stored in the paper tray to the ink jet head, and prints out a picture image on the paper by means of the ink jet head. The print device 22 executes printing in response to a command from the computing device 14.

### (Processes to be Carried Out by Printer 10 and External Devices)

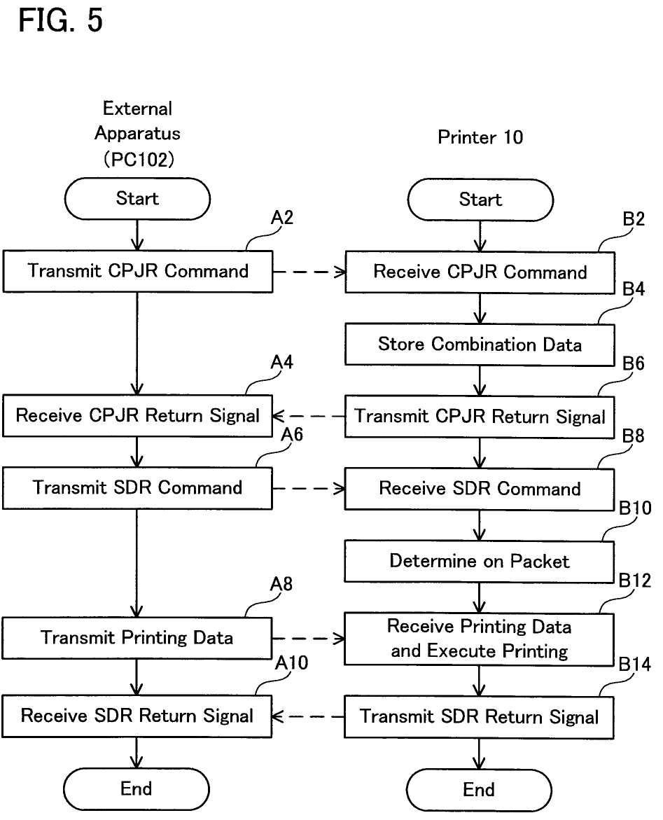

Processes for print execution of the printer 10 are described. When the printer 10 executes printing, a process shown in the flowchart of FIG. 5 is executed by an external apparatus and the printer 10. A dashed arrow shown in FIG. 5 represents the transmission and reception of information between the external apparatus and the printer 10. Details of each step are now described, using the PC 102 as an exemplary external apparatus which requests printing.

### (Transmission and Reception of CPJR Command)

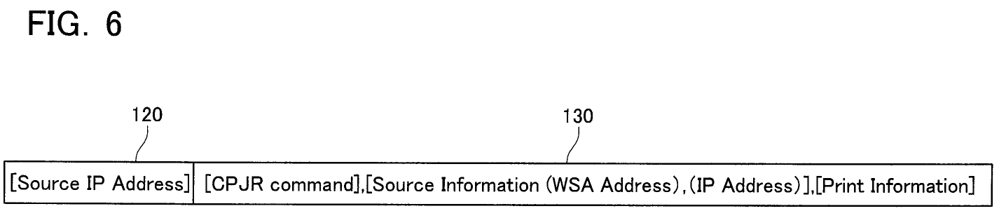

In print execution of the printer 10, a Create Print Job Request command (hereinafter referred to as a CPJR command) is transmitted from the PC 102 to the printer 10 (at Steps A2 and B2). FIG. 6 illustrates a composition of a packet for transmitting a CPJR command from the PC 102 to the printer 10. As shown in FIG. 6, the packet is composed of a header section 120 and a data section 130. In the header section 120, various information of the packet for transmission and reception are described. In the header section 120, a source IP address (that is, an IP address of the PC 102) is described, for example. In the data section 130a, CPJR command, source information, and print information are described. In the source information, a WSA address and an IP address of the external apparatus from which the packet is transmitted (that is, in this case a WSA address and an IP address of the PC 102) are described. In the print information, a name of the file to be printed, the number of pages to be printed, a size of data to be printed, and the like are described.

### (Storage of Combination Data)

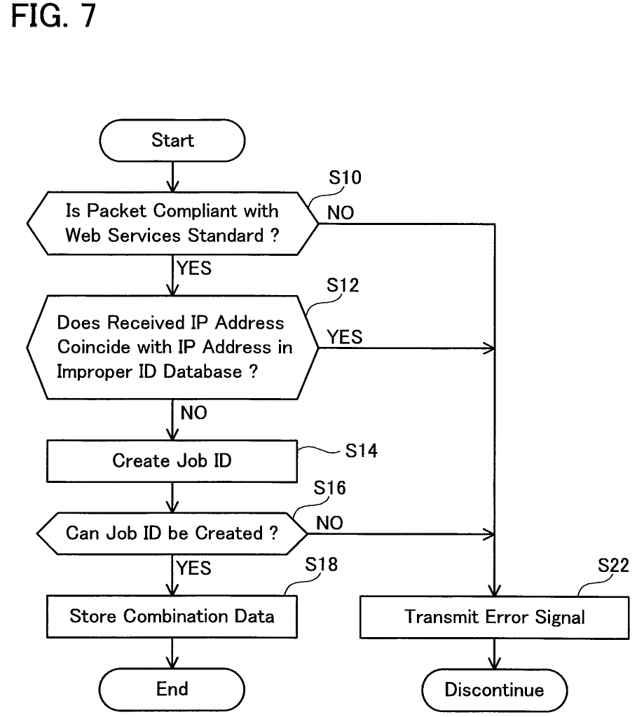

At step B4, the printer 10 stores combination data based on the packet of the received CPJR command. The printer 10 stores the combination data in accordance with the flowchart shown in FIG. 7.

At step S10, the printer 10 determines whether or not the packet of the received CPJR command is compliant with the Web Services standard. In a case where the packet is not compliant with the Web Services standard (determination ‘NO’ at Step S10), the printer 10 transmits an error signal to the external apparatus from which the CPJR command is transmitted (that is, the PC 102) at Step S22 and discontinues the process. In this case, combination data is not stored in the printer 10, and also printing will not be executed. In a case where the packet is compliant with the Web Services standard (determination ‘YES’ at Step S10), the printer 10 carries out the process shown in Step S12.

At Step S12, the printer 10 determines whether or not an IP address described in the header section 120 of the packet of the CPJR command coincides with any one of the improper IDs described in the improper ID database 32. As described above, the improper ID database 32 shows a list of IP addresses of the external apparatuses which have executed improper access. In a case where a received IP address described in the packet coincides with any one of the improper IDs (determination ‘YES’ at Step S12), the printer 10 carries out Step S22 and discontinues the process. In this case, the combination data is not stored in the printer 10 and also printing will not be executed. Thus, in a case where an IP address of the PC 102 is included in the improper ID database 32, a determination ‘YES’ is made at Step S12 and printing will not be executed. The packet of the CPJR command includes an IP address in the data section 130 and in the header section 120, as described above. However, there may be a case where the IP address described in the data section 130 is different from the actual IP address (in a case where the IP address in the data section 130 is improperly altered, for example). Therefore, the printer 10 compares the IP address described in the header section 120 to the improper IDs in the improper ID database 32. By utilizing the IP address in the header section 120, the CPJR command, transmitted from an external apparatus which has executed improper access, can surely be identified. On the other hand, in a case where the IP address does not coincide with the improper IDs (determination ‘NO’ at Step S12), the printer 10 carries out Step S14.

At Step S14, the printer 10 creates a job ID. In a case where plurality of requests for printer 10 exist (that is, the case where the printer 10 has received a plurality of CPJR commands), a plurality of combination data are described in the combination database 30. In this case, a job ID is created so that it does not to overlap with any job IDs that have been already described in the combination database 30. In addition, in a case where a large number of CPJR commands are transmitted to the printer 10, a large number of job IDs are used in parallel. In a case where there is no available job ID left because of use of a large number of job IDs, or because the number of job IDs used exceeds a predetermined limit, a determination ‘NO’ may be made at Step S16. Further, in a case where the combination database 30 can not store new combination data because of large quantity of data stored in the combination database 30, or because the capacity of combination database 30 is overloaded, a determination ‘NO’ may be made at Step S16. Furthermore, in a case where job IDs can not be created because of failure in a device to issue job IDs, a determination ‘NO’ may also be made at Step S16. In a case where a determination ‘NO’ is made at Step S16, the printer 10 carries out Step S22 and then discontinues the process.

When a job ID is created, the printer 10 carries out Step S18. At Step S18, the printer 10 creates combination data in such a manner that the job ID created at Step S14, the IP address described in the header section 120 of the packet of the CPJR command received at Step B2, and the WSA address described in the data section 130 (WSA address of the source information) are associated with each other to construct a combination thereof. The created combination data is written into the combination database 30. In other words, the combination data is stored. After the combination data is stored, the printer 10 completes the process in FIG. 7 (which in all construct the Step B4 shown in FIG. 5).

### (Transmission and Reception of CPJR Return Signal)

After the combination data is stored at Step B4, the printer 10 carries out Step B6. At Step B6, the printer 10 transmits a return signal (hereinafter referred to as a CPJR return signal) to the external apparatus which had transmitted the CPJR command (that is, the PC 102). Simultaneously, the printer 10 transmits the job ID created at Step S14 in FIG. 7 together with the CPJR return signal. The transmitted CPJR return signal and the job ID are received by the PC 102 at Step A4.

### (Transmission and Reception of SDR Command)

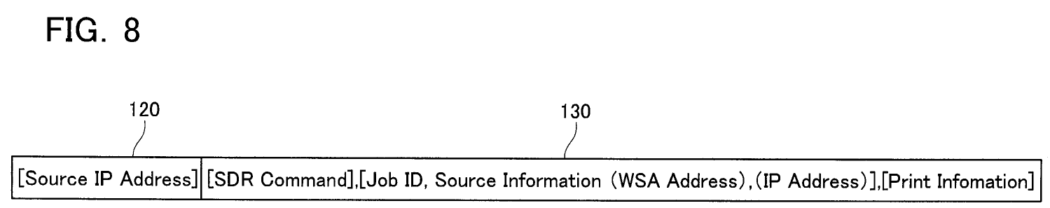

After receiving the CPJR return signal and the job ID, the PC 102 transmits a Send Document Request command (hereinafter referred to as a SDR command) and a job ID (the job ID received at Step A4) to the printer 10. A packet of the SDR command and the job ID to be transmitted at this time has the composition shown in FIG. 8. Specifically, an IP address of the PC 102 is described in the header section 120. Further, the SDR command, the job ID, the source information, and the print information are described in the data section 130. The above transmitted packet is received by the printer 10 at Step B8.

### (Determination on Packet)

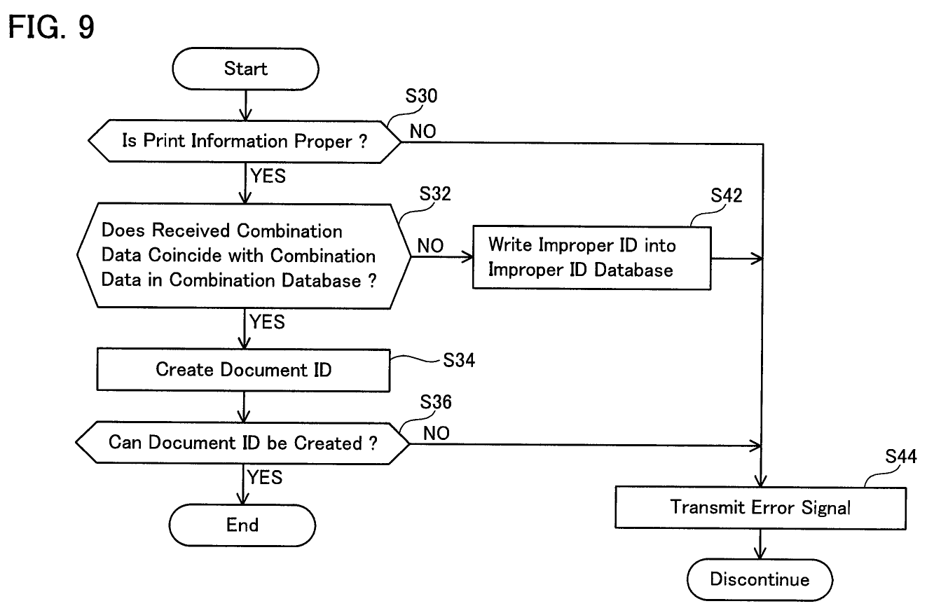

After receiving the packet of the SDR command and the job ID at Step B8, the printer 10 determines whether or not the received packet is proper at Step B10. The printer 10 makes a determination on the packet in accordance with the flowchart shown in FIG. 9.

At Step S30, the printer 10 determines whether or not print information received together with the SDR command is properly described. In a case where the print information is not proper (e.g., lacking necessary information), the printer 10 makes determination ‘NO’ at Step S30. In this case, the printer 10 transmits an error signal at Step S44 to the external apparatus which has transmitted the SDR command (that is, the PC 102), and discontinues the process. In this case, printing is not executed. In a case where the print information is properly described (determination ‘YES’ at Step S30), the printer 10 carries out Step S32.

At Step S32, the printer 10 determines whether or not the combination data received together with the SDR command at Step B8 in FIG. 5 (that is, the combination data which is composed of the job ID transmitted together with the SDR command, the IP address described in the header section 120 of the packet of the SDR command, and the WSA address described in the data section 130 of the packet) coincides with any one of the combination data described in the combination database 30. As described above, the combination data in the combination database 30 is described when the printer 10 receives a CPJR command from an external apparatus. Accordingly, a SDR command received together with combination data which is not in the combination database 30 is an improper SDR command which has been transmitted without going through the processes of Steps B2 to Step B6 in FIG. 5. In a case where the combination data received together with the SDR command does not coincide with the combination data in the combination database 30 (that is, the case where the SDR command is transmitted through improper access), the printer 10 makes a determination ‘NO’ at Step S32. For example, in a case where the PC 104 improperly obtains a job ID created for the PC 102 and transmits it together with a SDR command, a determination ‘NO’ is made at Step S32. In this case, an IP address received together with the SDR command (an IP address of the header section 120, that is, an IP address of the PC 104) and the job ID are written into the improper ID database 32 together with the time of receipt at Step S42. Then, the PC 104 becomes incapable of causing the printer 10 to execute printing (more specifically, once the PC 104 is recorded in the improper ID database 32, even in a case where the PC 104 transmits a CPJR command to the printer 10, a determination ‘YES’ will be made at Step S12 in FIG. 7, and thereby printing will not be executed). After carrying out Step S42, the printer 10 transmits an error signal to the PC 104 at Step S44 and discontinues the process. In this case, the printer 10 keeps waiting for a proper SDR command reception. When receiving a SDR command from an external apparatus (for example, the PC 102) after the aforementioned improper incident, the printer 10 carries out the flowchart shown in FIG. 9 again in regard to the newly received SDR command. On the other hand, in a case where combination data received together with a SDR command coincides with the combination data in the combination database 30, a determination ‘YES’ is made at Step S32. In a case where a SDR command from the PC 102 is received, a determination ‘YES’ is made here because the received combination data matches with one of the data stored in the combination database 30. In this case, the printer 10 carries out Step S34. As described above, when receiving a SDR command through improper access, the printer 10 does not carry out Step S34 and keeps waiting for another SDR command reception. The printer 10 carries out Step S34 only when receiving a proper SDR command. Thus, a printing job interruption due to improper access is prevented, and printing which has been properly requested can be reliably executed. It should be noted that, in the determination at Step S32, the printer 10 uses an IP address described in the header section 120 for combination data, not an IP address described in the data section 130 of the packet received. Therefore, a SDR command transmitted through improper access is surely identified.

At Step S34, the printer 10 creates a document ID. In a case where the PC 102 makes a print request to print a plurality of documents, an unique document ID is created for every document. In a case where no available document IDs are left because print request requests a large number of documents that exceeds the number of document IDs that may be assigned to the documents, a determination ‘NO’ may be made at Step S36. Further, in a case where it is impossible to cause a memory to store a new document ID because of huge quantity of data stored in the memory (that is, a case where the capacity of the storage for document ID is overloaded), a determination ‘NO’ may be made at Step S36. Furthermore, in a case where a document ID cannot be created because of failure in a device to create document IDs, a determination ‘NO’ may also be made at Step S36. In a case where a determination ‘NO’ is made at Step S36, the printer 10 carries out Step S44 and discontinues the process. On the other hand, in a case where a determination ‘YES’ is made at Step S36, the printer 10 completes the process shown in FIG. 9 (which in all construct the Step B10 in FIG. 5).

### (Reception of Data to be Printed Out and Print Execution)

After Step B10 is completed, the printer 10 receives printing data from the PC 102 and executes printing (at Steps A8 and B12). More specifically, after transmitting a SDR command at Step A6, the PC 102 begins to transmit printing data. Upon completion of Step B10, the printer 10 begins to receive printing data and executes printing based on the received printing data. After printing is completed, the printer 10 deletes the combination data of a job which printing is completed (that is, the combination data on which a determination ‘YES’ is made at Step S32) from the combination database 30.

### (Transmission and Reception of SDR Return Signal)

After completion of printing, the printer 10 transmits to the external apparatus which had transmitted the SDR command (that is, the PC 102) a return signal in response to the SDR command (at Steps A10 and B14). Then, the PC 102 may be informed of the completion of printing and the process in FIG. 5 is completed.

As described above, when receiving a CPJR command, the printer 10 according to this embodiment stores combination data received with a CPJR command. In the case where the combination data received with the CPJR command coincides with the stored combination data, printing is executed. On the other hand, in the case where the combination data received with the CPJR command does not coincide with the stored combination data, printing is not executed. Therefore, interruption of printing by an external apparatus which has not transmitted a CPJR command is prevented. Further, as a job ID is created at the time of receiving a CPJR command, the printer 10 is capable of distinguishing print requests per job ID. Thus, another print request (that is, a CPJR command) can be accepted (can be on print waiting state) even under print execution in accordance with a formerly-received print request. In other words, the printer 10 is capable of accepting in parallel a plurality of print requests.

Further, when receiving a SDR command together with combination data which is not described in the combination database 30, the printer 10 writes an IP address received with the SDR command into the improper ID database 32. Therefore, a supervisor or the like of the printer 10 can easily identify an external apparatus which has executed improper access.

Further, the printer 10 uses an IP address and a WSA address as combination data (that is, an external apparatus ID). Specifically, an IP address described in the header section 120 of a packet is used as an external apparatus ID. Thus, a SDR command transmitted through improper access can surely be identified.

### (Cancellation of Printing)

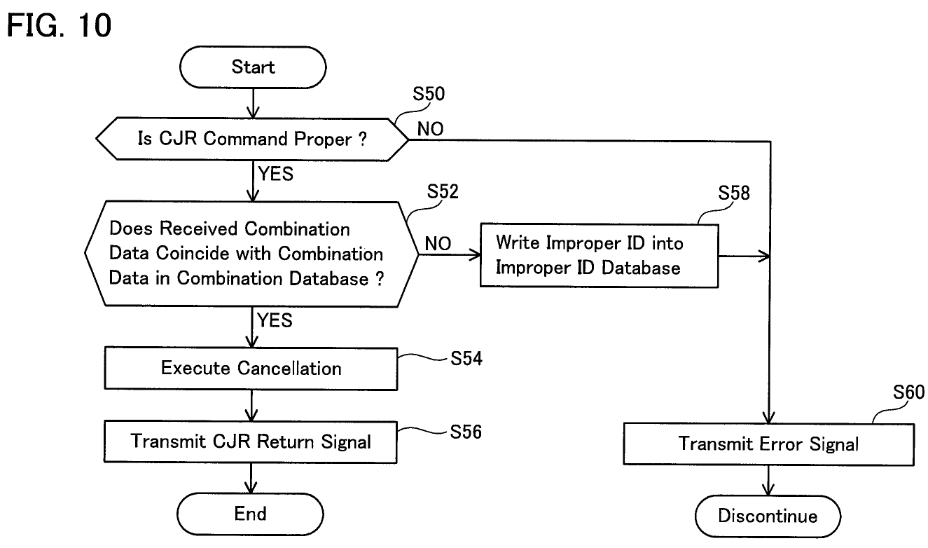

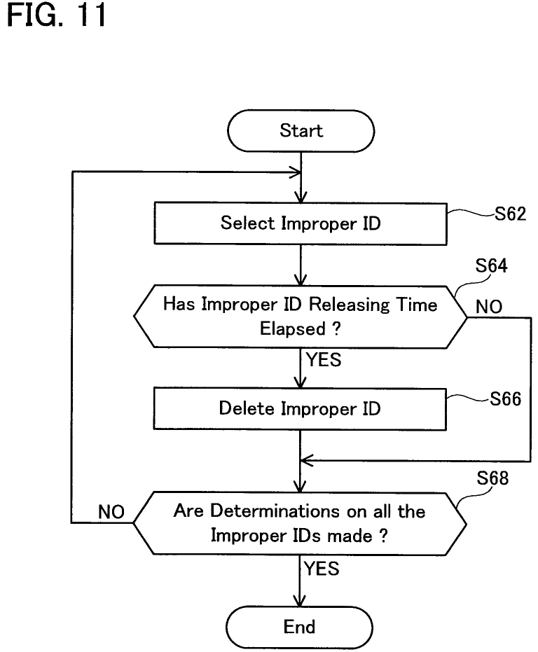

There may be a case where it is desired to cancel a job under print execution or a job in print waiting state. In this case, a Cancel Job Request command (hereinafter referred to as a CJR command) and a job ID are transmitted from the external apparatus which had made a print request to the printer 10. Thus, printing corresponding to the transmitted job ID can be canceled. An IP address is described in the header section 120 of a packet for transmitting a CJR command, and a WSA address is described in the data section 130 of the packet. After receiving a CJR command, the printer 10 carries out the process shown in the flowchart of FIG. 10.

At Step S50, the printer 10 determines whether or not a CJR command received is a proper command. In a case where the CJR command is not proper, for example, because of different format or the like, a determination ‘NO’ is made at Step S50. In this case, an error signal is transmitted to the external apparatus (external apparatus which transmitted the CJR command) at Step S60, and then the process is discontinued. In this case, cancellation is not executed.

At Step S52, the printer 10 determines whether or not combination data received with a CJR command (that is, combination data of a job ID received with the CJR command, an IP address described in the header section 120 of a packet of the CJR command, and a WSA address described in the data section 130 of the packet) coincides with any one of combination data described in the combination database 30. In a case where combination data does not coincide, it is considered that the CJR command is transmitted through improper access. Thus, in this case, a determination ‘NO’ is made at Step S52. For example, in a case where the PC 104 transmits the CJR command together with the job ID created to the PC 102, a determination ‘NO’ is made at Step S52. In a case where a determination ‘NO’ is made at Step S52, the printer 10 writes the IP address received with the CJR command into the improper ID database 32 at Step S58. After Step S58, Step S 60 is carried out, and then the process is discontinued. In this case, cancellation is not executed. On the other hand, in a case where a match is found with the combination data (determination ‘YES’ at Step S52), the printer 10 cancels printing that corresponds to the received job ID at Step S54. More specifically, in a case where printing corresponding to the job ID is not executed yet (that is, in print waiting state), the combination data corresponding to the job ID is deleted from the combination database 30. Therefore, printing corresponding to the job ID is not executed. Further, in a case where printing corresponding to the job ID received is under execution, the combination data corresponding to the job ID is deleted from the combination database 30 and further print execution is canceled.

After Step S54 is completed, at Step S56, the printer 10 transmits a return signal in response to the CJR command to the external apparatus which had transmitted the CJR command. Thus, the external apparatus is informed of cancellation completion.

As described above, the printer 10 according to this embodiment executes cancellation in a case where combination data received with a CJR command coincides with the stored combination data, and does not execute cancellation in a case where these combination data does not coincide. Therefore, the forced cancellation though improper access (that is, cancellation by an external apparatus different from the external apparatus which has made a print request) can be prevented.

### (Deleting Process of Improper ID)

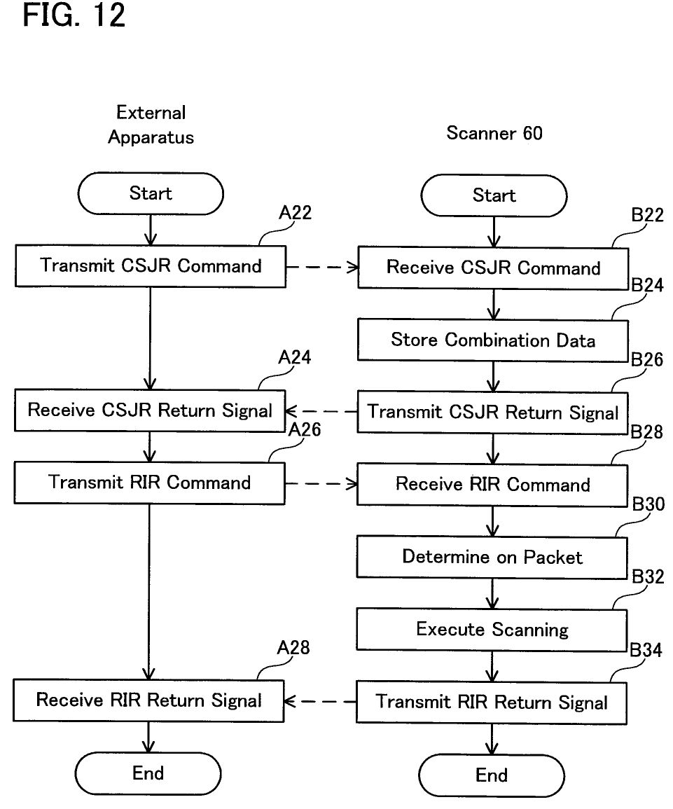

As described above, the printer 10 writes (stores) an improper ID into the improper ID database 32 in the case where there is improper access. The printer 10 according to this embodiment deletes the improper ID when a predetermined period (hereinafter referred to as an improper ID releasing period) has elapsed since improper access was executed. Now a deleting process of an improper ID from the improper ID database 32 is described. The flowchart shown in FIG. 11 illustrates the deleting process of an improper ID carried out by the printer 10.

After starting the deleting process of an improper ID, the printer 10 selects one improper ID from the improper ID database 32 at Step S62. Then, at Step S64, based on the present time and the improper access time of the selected improper ID, the printer 10 determines whether or not an improper ID releasing period has elapsed since the improper access corresponding to the selected improper ID was executed. In a case where the improper ID releasing period has elapsed (determination ‘YES’ at Step S64), the printer 10 deletes the improper ID at Step S66. In a case where the improper ID releasing period has not elapsed (determination ‘NO’ at Step S64), the printer 10 does not carry out Step S66 (that is, the printer 10 does not delete the improper ID). Next, at S68, the printer 10 determines whether or not determinations are made on all the improper IDs. In a case where the determinations on all the improper IDs are not completed (determination ‘NO’ at Step S68), Steps S62 through S68 are carried out again. At Step S62 which may be carried out in a second or succeeding attempt, improper IDs already determined are not selected. In a case where the determinations on all the improper IDs are completed (determination ‘YES’ Step S68), the printer 10 completes the process shown in FIG. 11. The printer 10 carries out the aforementioned process shown in FIG. 11 at fixed intervals. Thus, the corresponding improper IDs are deleted in periodical cycles from the improper ID database 32. Thus, the printer 10 becomes available to the external apparatus that had been corresponding to the deleted improper ID. By deleting the improper IDs based on an elapse of the improper ID releasing period in this manner, usability of external apparatuses is improved.

### Second Embodiment

A job executing apparatus according to a second embodiment is described. In the second embodiment, a scanner 60 which functions as the job executing apparatus is described. The scanner 60 is connected with the LAN 100 as with the printer 10. Further, the scanner 60 has composition such that the print device 22 is replaced with a scanner device in the composition of the printer 10 shown in FIG. 2. The scanner device executes scanning in response to a command from a computing device. Further, a storage device of the scanner 60 stores a combination database and an improper ID database as with the printer 10.

After a request to the scanner 60 for scanning is made by an external apparatus, the scanner 60 executes the process shown in the flowchart of FIG. 12.

At Steps A22 and B22, an external apparatus transmits a Create Scan Job Request command (hereinafter referred to as a CSJR command) to the scanner 60. Contents of a packet of the CSJR command is same as that of the CPJR command shown in FIG. 6 except for the following different points: the first different point is that the command name described in data section is different, and the second different point is that scanning information (information required for carrying out scanning such as a scanning area and resolution) is described in the data section instead of the print information. After receiving a CSJR command, at Step B24, the scanner 60 writes combination data into a combination database through a process as with the process shown in FIG. 7. At Steps A24 and B26, the scanner 60 transmits to the external apparatus a return signal (CSJR return signal) in response to the CSJR command. At this time, a job ID is also transmitted together with the CSJR return signal. When receiving the CSJR return signal and the job ID, the external apparatus transmits a Retrieve Image Request command (hereinafter refereed to as a RIR command) to the scanner 60 at Step A26. Contents of the packet of the RIR command is same as that of the SDR command shown in FIG. 6 except for the differences in the command names and a description of the scanning information instead of the print information. The transmitted RIR command is received by the scanner 60 at Step B28. After receiving the RIR command, the scanner 60 makes a determination on the packet at Step B30 and executes scanning at Step B32 through a process as with the process shown in FIG. 9. More specifically, in a case where combination data received together with the RIR command coincides with the combination data described in the combination database, scanning is executed, and in a case where these combination data does not coincide, scanning is not executed. Therefore, interruption scanning through improper access can be prevented. After the completion of scanning, the printer 10 transmits to the external apparatus (external apparatus which transmitted the RIR command) a return signal in response to the RIR command and scanned image data (at Steps A28 and B34), and then completes the process.

As described above, by the printer 10 and the scanner 60 according to the aforementioned embodiments, the job interruption through improper access can be prevented. It should be noted that the techniques described in this specification is applicable to various job executing apparatus, such as a digital camera, a facsimile, a measuring instrument, and a robot.

A part of technique disclosed in the above embodiments will be described.

The job executing apparatus may comprise an improper ID storing device configured to store the external apparatus ID received with the second command in a case where the second command determination device makes the negative determination (i.e., the determination indicating that the combination data received with the second command is not stored in the storing device). By means of this job executing apparatus, user can identify an external apparatus, which attempted to execute improper access such as job interruption, from the external apparatus ID stored in the improper ID storing device.

The job executing apparatus may comprise an improper ID determination device configured to determine, in a case where the receiving device receives the first command and the external apparatus ID, whether or not the external apparatus ID received with the first command is stored in the improper ID storing device. The job ID creation device may create the job ID in a case where the improper ID determination device makes a negative determination (i.e., the determination indicating that the external apparatus ID received with the first command is not stored in the improper ID storing device), and the job ID creation device may not create the job ID in a case where the improper ID determination device makes a positive determination (i.e., the determination indicating that the external apparatus ID received with the first command is stored in the improper ID storing device). In this composition, even in a case where the first command is transmitted by an external apparatus which previously had attempted to execute improper access, the job executing apparatus may not execute the job. Note that the external apparatus ID stored in the improper ID storing device may be deleted when the predetermined conditions are satisfied. For example, the external apparatus ID can be deleted after a predetermined period has passed since the external apparatus ID was stored in the improper ID storing device.

The job executing device may comprise a cancel command determination device and a job canceling device. The cancel command determination device may be configured to determine, in a case where the receiving device receives a cancel command, a job ID, and an external apparatus ID of an external apparatus, whether or not combination data of the job ID and the external apparatus ID received with the cancel command is stored in the storing device. The job canceling device may be configured to cancel a job corresponding to the job ID received with the cancel command in a case where the cancel command determination device makes a positive determination (i.e., the determination indicating that the combination data received with the cancel command is stored in the storing device), and configured to prohibit canceling the job corresponding to the job ID received with the cancel command in a case where the cancel command determination device makes a negative determination (i.e., the determination indicating that the combination data received with the cancel command is not stored in the storing device). In this composition, the problem which occurs in a job executing apparatus comprising only the canceling device is prevented. That is, a problem that a job requested by an external apparatus is canceled by another apparatus (that is, forced cancellation) is prevented.

The job executing apparatus may comprise an improper ID storing device configured to store the external apparatus ID received with the cancel command in a case where the cancel command determination device makes the negative determination. By means of this job executing apparatus, user can identify an external apparatus, which attempted to execute improper access such as forced cancellation, from the external apparatus ID stored in the improper ID storing device.

The job executing apparatus may comprise an improper ID determination device configured to determine, in a case where the receiving device receives the first command and the external apparatus ID, whether or not the external apparatus ID received with the first command is stored in the improper ID storing device. The job ID creation device may create the job ID in a case where the improper ID determination device makes a negative determination, and the job ID creation device may not create the job ID in a case where the improper ID determination device makes a positive determination. In this composition, even in a case where the first command is transmitted by an external apparatus which has attempted to execute forced cancellation previously, the job executing apparatus may not execute the job.

As the external apparatus ID of an external apparatus, at least one of an IP address (Internet Protocol Address) of the external apparatus and a WSA address (an address which is allocated to each apparatus using the Web Services standard) of the external apparatus can be utilized. Further, other ID can be utilized.

Furthermore, in a case where an IP address is utilized as an external apparatus ID, a source IP address included in a header of a packet can be utilized as the external apparatus ID. The source IP address is a high-integrity information which can not be faked. Therefore, the job executing apparatus can identify an external apparatus which sends a command.

What is claimed is:

1. A job executing apparatus for executing a job in response to a received command, the job executing apparatus comprising:
a receiving device configured to receive a command;
a job ID creation device configured to create a job ID in a case where the receiving device receives a first command and an external apparatus ID of an external apparatus;
a sending device configured to send the job ID to the external apparatus;
a storing device configured to store combination data of the job ID and the external apparatus ID;
a second command determination device configured to determine, in a case where the receiving device receives a second command, a job ID, and an external apparatus ID of an external apparatus, whether or not combination data of the job ID and the external apparatus ID received with the second command is stored in the storing device; and
a job executing device configured to execute a job corresponding to the job ID received with the second command in a case where the second command determination device makes a positive determination, and configured to prohibit executing the job corresponding to the job ID received with the second command in a case where the second command determination device makes a negative determination.

2. The job executing apparatus as in claim 1, further comprising:
an improper ID storing device configured to store the external apparatus ID received with the second command in a case where the second command determination device makes the negative determination.

3. The job executing apparatus as in claim 2, further comprising:
an improper ID determination device configured to determine, in a case where the receiving device receives the first command and the external apparatus ID, whether or not the external apparatus ID received with the first command is stored in the improper ID storing device,
wherein the job ID creation device creates the job ID in a case where the improper ID determination device makes a negative determination, and the job ID creation device does not create the job ID in a case where the improper ID determination device makes a positive determination.

4. The job executing apparatus as in claim 1, further comprising:
a cancel command determination device configured to determine, in a case where the receiving device receives a cancel command, a job ID, and an external apparatus ID of an external apparatus, whether or not combination data of the job ID and the external apparatus ID received with the cancel command is stored in the storing device; and
a job canceling device configured to cancel a job corresponding to the job ID received with the cancel command in a case where the cancel command determination device makes a positive determination, and configured to prohibit canceling the job corresponding to the job ID received with the cancel command in a case where the cancel command determination device makes a negative determination.

5. The job executing apparatus as in claim 4, further comprising:
an improper ID storing device configured to store the external apparatus ID received with the cancel command in a case where the cancel command determination device makes the negative determination.

6. The job executing apparatus as in claim 5, further comprising:
an improper ID determination device configured to determine, in a case where the receiving device receives the first command and the external apparatus ID, whether or not the external apparatus ID received with the first command is stored in the improper ID storing device,
wherein the job ID creation device creates the job ID in a case where the improper ID determination device makes a negative determination, and the job ID creation device does not create the job ID in a case where the improper ID determination device makes a positive determination.

7. The job executing apparatus as in claim 1,
wherein the external apparatus ID is at least one of an IP address and a WSA address.

8. The job executing apparatus as in claim 1,
wherein the external apparatus ID is a source IP address included in a header of a packet.

9. A method of executing a job in response to a received command, the method comprising:
receiving a first command and an external apparatus ID of an external apparatus;
creating a job ID in a case where the first command and the external apparatus ID are received;
sending the job ID to the external apparatus;
storing combination data of the job ID and the external apparatus ID in a storing device;
receiving a second command, a job ID, and an external apparatus ID of an external apparatus;
determining whether or not combination data of the job ID and the external apparatus ID received with the second command is stored in the storing device;
executing a job corresponding to the job ID received with the second command in a case where a positive determination is obtained; and
prohibiting executing the job corresponding to the job ID received with the second command in a case where a negative determination is obtained.

10. The method as in claim 9, further comprising:
storing the external apparatus ID received with the second command in an improper ID storing device in a case where the negative determination is obtained.

11. The method as in claim 10, further comprising:
determining, in a case where the first command and the external apparatus ID are received, whether or not the external apparatus ID received with the first command is stored in the improper ID storing device;
wherein the job ID is created in a case where a negative determination for the external apparatus ID received with the first command is obtained, and the job ID is not created in a case where a positive determination for the external apparatus ID received with the first command is obtained.

12. The method as in claim 9, further comprising:
receiving a cancel command, a job ID, and an external apparatus ID of an external apparatus,
determining, in a case where the cancel command, the job ID, and the external apparatus ID are received, whether or not combination data of the job ID and the external apparatus ID received with the cancel command is stored in the storing device;
canceling a job corresponding to the job ID received with the cancel command in a case where a positive determination for the combination data received with the cancel command is obtained; and
prohibiting canceling the job corresponding to the job ID received with the cancel command in a case where a negative determination for the combination data received with the cancel command is obtained.

13. The method as in claim 12, further comprising:
storing the external apparatus ID received with the cancel command in an improper ID storing device in a case where the negative determination for the combination data received with the cancel command is obtained.

14. The method as in claim 13, further comprising:
determining, in a case where the first command and the external apparatus ID are received, whether or not the external apparatus ID received with the first command is stored in the improper ID storing device,
wherein the job ID is created in a case where a negative determination for the external apparatus ID received with the first command is obtained, and the job ID is not created in a case where a positive determination for the external apparatus ID received with the first command is obtained.

15. The method as in claim 9,
wherein the external apparatus ID is at least one of an IP address and a WSA address.

16. The method as in claim 9,
wherein the external apparatus ID is a source IP address included in a header of a packet.
